(19) United States
(12) Patent Application Publication
(10) Pub. No.: US 2013/0153406 A1
(43) Pub. Date: Jun. 20, 2013

(54) METHODS OF MANUFACTURING METAL OXIDE NANOPARTICLES

(71) Applicants: Jiyoung Oh, Daejeon (KR); SangChul Lim, Daejeon (KR); Chul Am Kim, Daejeon (KR)

(72) Inventors: Jiyoung Oh, Daejeon (KR); SangChul Lim, Daejeon (KR); Chul Am Kim, Daejeon (KR)

(73) Assignee: ELECTRONICS AND TELECOMMUNICATIONS RESEARCH INSTITUTE, Daejeon (KR)

(21) Appl. No.: 13/608,623

(22) Filed: Sep. 10, 2012

(30) Foreign Application Priority Data
Dec. 14, 2011 (KR) 10-2011-0134355

(51) Int. Cl. B01J 19/10; B82Y 40/00; B82Y 99/00

(52) U.S. Cl. 204/157.42; 977/773; 977/840

(57) ABSTRACT

Methods of manufacturing metal oxide nanoparticles are provided. The method uses a bubble generation ultrasonic synthesis method. A gas is injected into a metal oxide preliminary composition solution to promote length growth of nanoparticles. After a basic chemical species solution is mixed with the metal oxide preliminary composition solution, ultrasonic waves are applied to form a reactant. The reactant is refined to manufacture metal oxide nanoparticles. The nanoparticles may have excellent dispersibility and a uniform thin film may be formed by the nanoparticles.

### CROSS-REFERENCE TO RELATED APPLICATIONS

This U.S. non-provisional patent application claims priority under 35 U.S.C. §119 to Korean Patent Application No. 10-2011-0134355, filed on Dec. 14, 2011, the entirety of which is incorporated by reference herein.

### BACKGROUND

The inventive concept relates to methods of manufacturing metal oxide nanoparticles and, more particularly, to methods of manufacturing metal oxide nanoparticles using a bubble generation ultrasonic synthesis method.

An oxide thin film may be formed by a physical vapor deposition (PVD) method such as a vacuum deposition method and a sputtering method, or a chemical vapor deposition (CVD) method such as a thermal CVD method and a plasma CVD method. The methods may need large vacuum equipments, such that manufacturing costs may increase and productivity may decrease.

A sol-gel method and hydrothermal method, which are a kind of liquid methods, have been suggested as an alternative to the above method. In the sol-gel method, a thin film may be coated using a precursor solution and then the thin film may be thermally treated at 400 degrees Celsius or more to form the metal oxide thin film. Thus, the sol-gel method is not applied to a plastic substrate requiring a low temperature process. Nanoparticles formed by the hydrothermal method may have small sizes within a range of several micrometers to several tens micrometers and be non-uniform. Additionally, the nanoparticles formed by the hydrothermal method may have bad dispersibility. Thus, it is difficult to form a uniform thin film by the hydrothermal method. Therefore, it is required to develop a method of manufacturing metal oxide nanoparticles capable of easily forming a uniform thin film at a low temperature.

### SUMMARY

Embodiments of the inventive concept may provide methods of manufacturing metal oxide nanoparticles having uniform sizes.

According to embodiments of the inventive concept, a method of manufacturing metal oxide nanoparticles may include: forming a metal oxide preliminary composition solution; mixing the metal oxide preliminary composition solution with a basic chemical species solution to form a mixture solution; applying ultrasonic waves to the mixture solution to form a reactant; and removing a solvent of the reactant.

In some embodiments, the method may further include: injecting a gas into the metal oxide preliminary composition solution.

In other embodiments, the gas may include oxygen, nitrogen, argon, or vapor.

In still other embodiments, the metal oxide preliminary composition solution may be an alcohol-based solution including metal acetate, metal alkoxide, metal nitrade, metal halide, any hydrate thereof, or any combination thereof.

In yet other embodiments, the metal acetate, metal alkoxide, metal nitrade, metal halide, any hydrate thereof, or any combination thereof may have a molarity within a range of about 0.1M to about 1M in the alcohol-based solution.

In yet still other embodiments, the basic chemical species solution may be a mixture of a basic chemical species and an alcohol-based solvent.

In yet still other embodiments, the basic chemical species may include LiOH, NaOH, KOH, NH4OH, Na2O2, any hydrate thereof, or any combination thereof.

In yet still other embodiments, the ultrasonic waves may have a frequency within a range of about 30 kHz to about 100 kHz.

In yet still other embodiments, the ultrasonic waves may have a power within a range of about 600 W to about 3000 W.

In yet still other embodiments, the solvent of the reactant may be removed using a centrifuge method.

### BRIEF DESCRIPTION OF THE DRAWINGS

The inventive concept will become more apparent in view of the attached drawings and accompanying detailed description.

FIG. 1 is an x-ray diffraction (XRD) graph of zinc oxide nanoparticles manufactured according to a first embodiment of the inventive concept;

FIG. 2 is a scanning electron microscope (SEM) photograph of a surface of a thin film formed of zinc oxide nanoparticles manufactured according to a first embodiment of the inventive concept;

FIG. 3 is a SEM photograph of a cross section of a thin film formed of zinc oxide nanoparticles manufactured according to a first embodiment of the inventive concept;

FIG. 4 is a SEM photograph of a surface of a thin film formed of zinc oxide nanoparticles manufactured according to a second embodiment of the inventive concept;

FIG. 5 is a SEM photograph of a surface of a thin film formed of zinc oxide nanoparticles manufactured according to a third embodiment of the inventive concept;

FIG. 6 is a photoluminescence (PL) analysis graph of thin films formed of zinc oxide nanoparticles according to embodiments of the inventive concept;

FIG. 7 is a perspective view illustrating a bubble injection apparatus used in methods of forming metal oxide nanoparticles according to embodiments of the inventive concept;

FIG. 8 is a perspective view illustrating a bubble generator inserted in a reaction container of the bubble injection apparatus of FIG. 7; and

FIG. 9 is a perspective view illustrating a bottom surface of the bubble generator of FIG. 8.

### DETAILED DESCRIPTION OF THE EMBODIMENTS

The inventive concept will now be described more fully hereinafter with reference to the accompanying drawings, in which exemplary embodiments of the inventive concept are shown. The advantages and features of the inventive concept and methods of achieving them will be apparent from the following exemplary embodiments that will be described in more detail with reference to the accompanying drawings. It should be noted, however, that the inventive concept is not limited to the following exemplary embodiments, and may be implemented in various forms. Accordingly, the exemplary embodiments are provided only to disclose the inventive concept and let those skilled in the art know the category of the inventive concept. In the drawings, embodiments of the inventive concept are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Additionally, the embodiment in the detailed description will be described with sectional views as ideal exemplary views of the inventive concept. Accordingly, shapes of the exemplary views may be modified according to manufacturing techniques and/or allowable errors. Therefore, the embodiments of the inventive concept are not limited to the specific shape illustrated in the exemplary views, but may include other shapes that may be created according to manufacturing processes. Areas exemplified in the drawings have general properties, and are used to illustrate specific shapes of elements. Thus, this should not be construed as limited to the scope of the inventive concept.

It will be also understood that although the terms first, second, third etc. may be used herein to describe various elements, these elements should not be limited by these terms. These terms are only used to distinguish one element from another element. Thus, a first element in some embodiments could be termed a second element in other embodiments without departing from the teachings of the present invention. Exemplary embodiments of aspects of the present inventive concept explained and illustrated herein include their complementary counterparts. The same reference numerals or the same reference designators denote the same elements throughout the specification.

According to embodiments of the inventive concept, synthesis of metal oxide nanoparticles may be performed in an ultrasonic reaction container. A frequency of the ultrasonic reaction container may have a range of about 30 kHz to about 100 kHz. A power of the ultrasonic reaction container may have a range of about 600 W to about 3000 W. A reaction temperature of the ultrasonic reaction container may have a range of about 0 degree Celsius to about 100 degrees Celsius.

A metal oxide preliminary composition solution for the synthesis of the metal oxide nanoparticles may be an alcohol-based solution including metal acetate, metal alkoxide, metal nitrade, metal halide, any hydrate thereof, or any combination thereof. Metal acetate, metal alkoxide, metal nitrade, metal halide, any hydrate thereof, or any combination thereof may have a molarity within a range of about 0.1M to about 1M in the alcohol-based solution.

For the synthesis of the metal oxide nanoparticles, a gas may be injected into the reaction container in which the metal oxide preliminary composition solution is included. Length growth of the nanoparticles may be promoted due to bubbles generated by injecting the gas. The gas may include at least one of oxygen, nitrogen, argon, or vapor.

A basic chemical species solution may be added to the metal oxide preliminary composition solution. The basic chemical species solution may include a basic chemical species and an alcohol-based solvent. The basic chemical species may include LiOH, NaOH, KOH, NH4OH, Na2O2, any hydrate thereof, or any combination thereof.

A reaction mixture may be generated by reaction of the metal oxide preliminary composition solution and the basic chemical species solution. The reaction may be controlled by concentrations of the solutions, a suitable adding speed, an intensity of ultrasonic waves, and/or a temperature of a constant-temperature container. Sizes of the metal oxide nanoparticles may be controlled by the control of the reaction.

A mean diameter of the metal oxide nanoparticles according to embodiments of the inventive concept may be about 100 nm or less. The metal oxide nanoparticles may have an excellent dispersibility in various solvents and be capable of forming a stable metal oxide nano-ink. The solvent may include water or an alcohol-based solvent. The nano-ink may be formed into a thin film by a spin coating method, a deep coating method, a gravure coating method, a screen coating method, or a spray coating method. The thin film using the metal oxide nano-ink may be formed at a temperature within a range of about 20 degrees Celsius to about 200 degrees Celsius.

The solvent of the metal oxide thin film may be evaporated under a vacuum of a room temperature or a low temperature. A thickness of the metal oxide thin film may have a range of about 5 nm to about 500 nm. The thickness of the metal oxide thin film may be changed according to a type of a formed device layer and/or a use of an electronic device. Pattering of the metal oxide thin film may use an inkjet print technique or a mask technique. Additionally, the Pattering of the metal oxide thin film may use a photolithography.

According to embodiments of the inventive concept, the synthesis of the metal oxide nanoparticles may be simple, the metal oxide nanoparticles may have an excellent dispersibility, and a uniform thin film may be formed. Thus, the method of forming the metal oxide nanoparticles according to embodiments may be applied to various devices formed on a flexible substrate (a plastic substrate) which needs a low temperature process after the formation of the thin film.

Hereinafter, the inventive concept will be described in more detail with reference to embodiments. However, a scope of the inventive concept is not limited to the following embodiments.

### First Embodiment

Zinc acetate of about 8.84 g and methanol of about 75 ml are mixed in a reaction container. KOH of about 4.44 g and methanol of about 39 ml are mixed in another reaction container. The KOH mixture solution is added to the zinc acetate mixture solution. The mixed solutions are put in the ultrasonic reaction container and then are reacted for about 6 hours. The reactant is centrifuged to remove the solvent. The reactant from which the solvent is removed is dispersed in methanol of about 100 ml. And then a solvent is removed again. The above process is repeated three times, such that zinc oxide nanoparticles are refined.

The refined zinc oxide nanoparticles are dispersed in methanol of about 40 ml to manufacture a nano-ink. The nano-ink is spin-coated on a glass substrate at 2000 rpm for 30 seconds, thereby forming a thin film. The thin film is dried at a room temperature and then is analyzed.

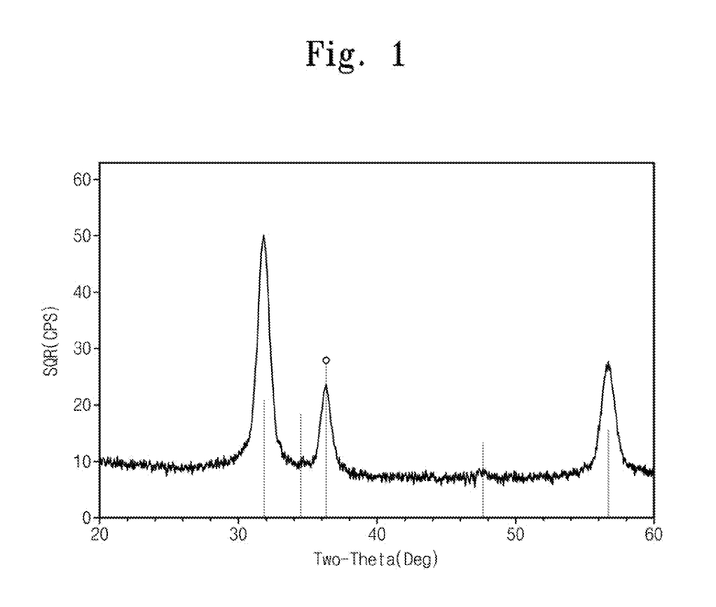

FIG. 1 is an x-ray diffraction (XRD) graph of zinc oxide nanoparticles manufactured according to a first embodiment of the inventive concept. Referring to FIG. 1, the XRD graph shows crystalline property of the zinc oxide nanoparticles. In other words, it is confirmed that impurities of the zinc oxide nanoparticles are removed by the refining process.

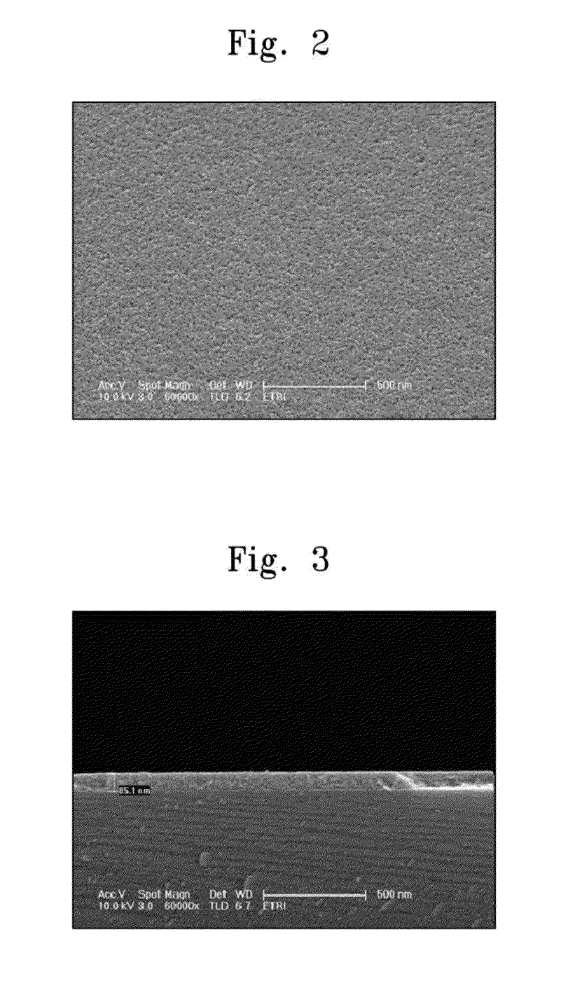

FIG. 2 is a scanning electron microscope (SEM) photograph of a surface of a thin film formed of zinc oxide nanoparticles manufactured according to a first embodiment of the inventive concept. Referring to FIG. 2, it is confirmed that a surface of the thin film is substantially uniform.

FIG. 3 is a SEM photograph of a cross section of a thin film formed of zinc oxide nanoparticles manufactured according to a first embodiment of the inventive concept. Referring to FIG. 3, the cross section of the thin film is substantially uniform.

### Second Embodiment

Zinc acetate of about 8.84 g and methanol of about 75 ml are mixed in a reaction container. KOH of about 4.44 g and methanol of about 39 ml are mixed in another reaction container. A gas injector is inserted in the zinc acetate mixture solution and then an oxygen gas is injected in 500 cc per a minute. After the oxygen gas (i.e., bubbles) is injected for about 10 minutes, the KOH mixture solution is added to the zinc acetate mixture solution. The mixed solutions are put in the ultrasonic reaction container and then are reacted for about 6 hours. The oxygen gas is continuously injected into the ultrasonic reaction container during the reaction of the mixed solutions. After the reaction is finished, the reactant is centrifuged to remove the solvent. The reactant from which the solvent is removed is mixed with methanol of about 100 ml. And then the resultant product is centrifuged to remove a solvent again. The above process is repeated three times, such that zinc oxide nanoparticles are refined.

The refined zinc oxide nanoparticles are dispersed in methanol of about 40 ml to manufacture a nano-ink. The nano-ink is spin-coated on a glass substrate at 2000 rpm for 30 seconds, thereby forming a thin film. The thin film is dried at a room temperature and then is analyzed.

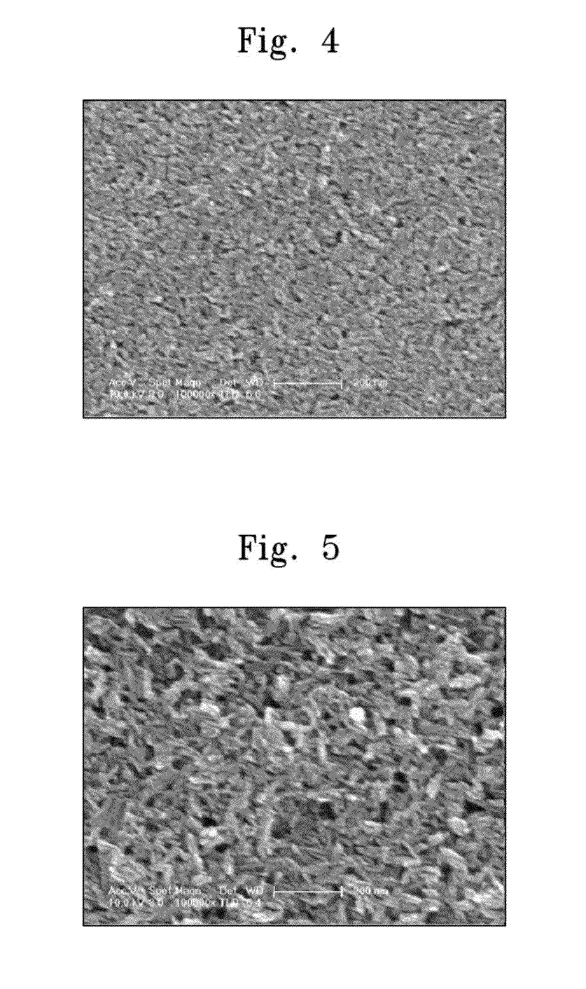

FIG. 4 is a SEM photograph of a surface of a thin film formed of zinc oxide nanoparticles manufactured according to a second embodiment of the inventive concept. Referring to FIG. 4, the thin film is densely formed.

### Third Embodiment

Zinc acetate of about 8.84 g and methanol of about 75 ml are mixed in a reaction container. KOH of about 4.44 g and methanol of about 39 ml are mixed in another reaction container. A gas injector is inserted in the zinc acetate mixture solution and then a nitrogen gas is injected in 500 cc per a minute. After the nitrogen gas (i.e., bubbles) is injected for about 10 minutes, the KOH mixture solution is added to the zinc acetate mixture solution. The mixed solutions are put in the ultrasonic reaction container and then are reacted for about 6 hours. The nitrogen gas is continuously injected into the ultrasonic reaction container during the reaction of the mixed solutions. After the reaction is finished, the reactant is centrifuged to remove the solvent. The reactant from which the solvent is removed is mixed with methanol of about 100 ml. And then the resultant product is centrifuged to remove a solvent again. The above process is repeated three times, such that zinc oxide nanoparticles are refined.

The refined zinc oxide nanoparticles are dispersed in methanol of about 40 ml to manufacture a nano-ink. The nano-ink is spin-coated on a glass substrate at 2000 rpm for 30 seconds, thereby forming a thin film. The thin film is dried at a room temperature and then is analyzed.

FIG. 5 is a SEM photograph of a surface of a thin film formed of zinc oxide nanoparticles manufactured according to a third embodiment of the inventive concept. Referring to FIG. 5, the thin film of FIG. 4 is denser than the thin film of FIG. 5. In other words, the thin film formed of the zinc oxide nanoparticles manufactured by injecting the oxygen gas has a crystalline property higher than that of the thin film formed of the zinc oxide nanoparticles manufactured by injecting the nitrogen gas.

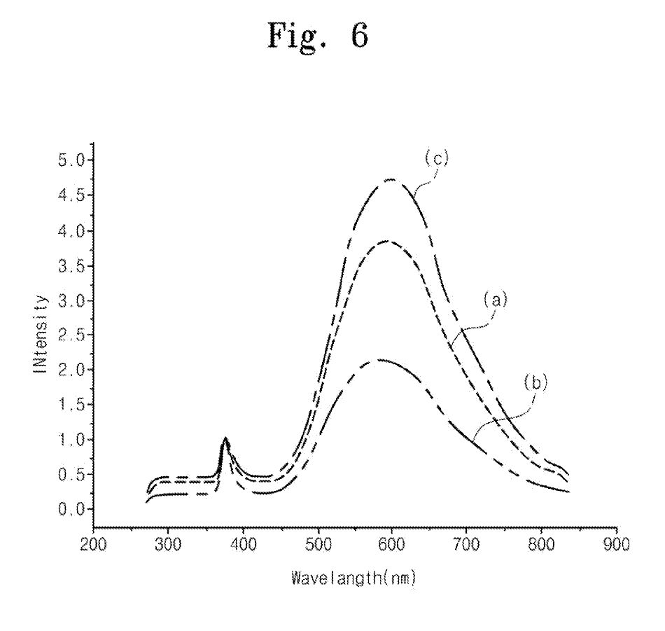

FIG. 6 is a photoluminescence (PL) analysis graph of thin films formed of zinc oxide nanoparticles according to embodiments of the inventive concept.

Referring to FIG. 6, the zinc oxide has an energy band gap of about 3.34 eV. Thus, light is generated in a region of about 377 nm when the zinc oxide is measured by a photoluminescence (PL). In other words, as an intensity of a band edge peak of about 377 nm becomes stronger, the crystalline property becomes higher. A peak generated by a deep level of about 600 nm relates to thin film defects. In other words, as the intensity of the peak of about 600 nm becomes stronger, defects (e.g., vacancies and/or interstitial atoms) of the thin film becomes increased.

Thus, the zinc oxide nanoparticles thin film (a) formed without injection of a gas according to the first embodiment includes defects less than those of the zinc oxide nanoparticles thin film (c) of the third embodiment and more than those of the zinc oxide nanoparticles thin film (b) of the second embodiment. The zinc oxide nanoparticles thin film (b) formed by injecting the oxygen gas according to the second embodiment includes the least defects. The zinc oxide nanoparticles thin film (c) formed by injecting the nitrogen gas according to the third embodiment includes the most defects.

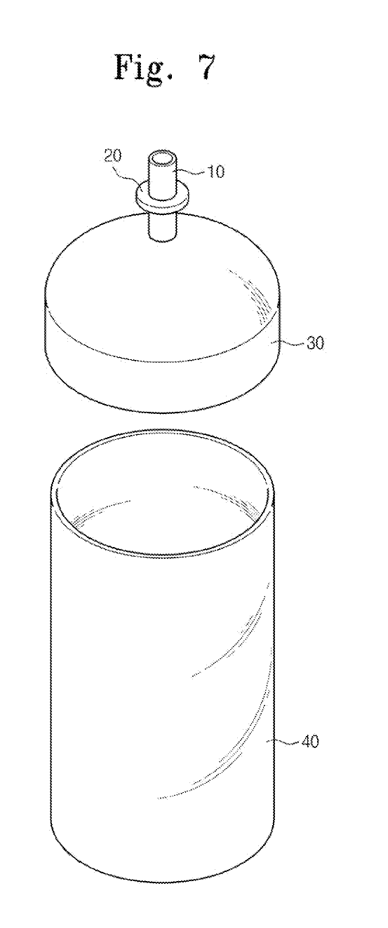

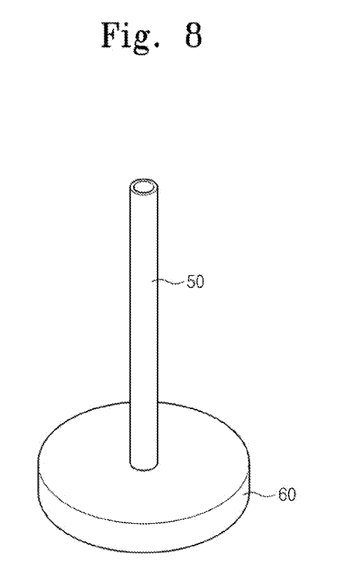

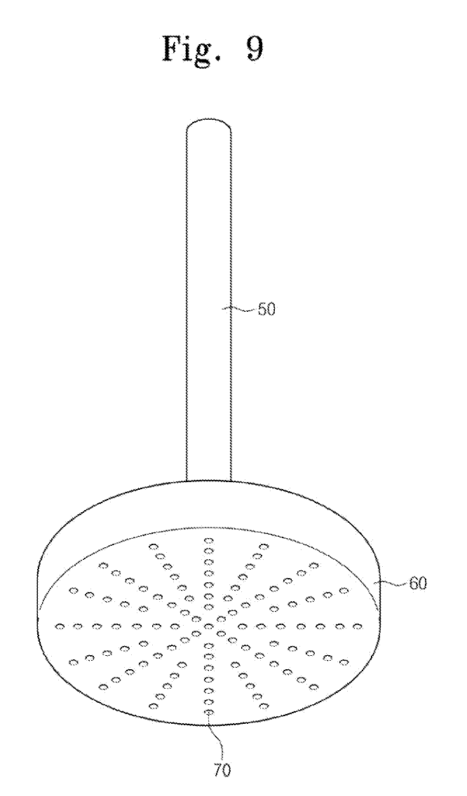

FIG. 7 is a perspective view illustrating a bubble injection apparatus used in methods of forming metal oxide nanoparticles according to embodiments of the inventive concept. FIG. 8 is a perspective view illustrating a bubble generator inserted in a reaction container of the bubble injection apparatus of FIG. 7. FIG. 9 is a perspective view illustrating a bottom surface of the bubble generator of FIG. 8.

Referring to FIG. 7, a bubble injection apparatus may include a first connection pipe 10, a Teflon valve 20, a cover 30, and a reaction container 40. Referring to FIG. 8, the bubble generator may include a second connection pipe 50 and a bubble injector 60. Referring to FIG. 9, the bubble generator 60 may include gas injecting holes 70 at a bottom surface thereof.

The first connection pipe 10 may penetrate the cover 30. A top end part of the first connection pipe 10 may be connected to a gas line (not shown). A gas may be injected through the gas line. A bottom end part of the first connection pipe 10 may be connected to a top end part of the second connection pipe 50 by a tube (not shown). In the state that the bottom end part of the first connection pipe 10 is connected to the top end part of the second connection pipe 50 by a tube, the bubble generator including the second connection pipe 50 and the bubble injector 60 may be inserted into the reaction container 40. The amount of the gas injected through the gas line may be controlled by using the Teflon valve 20.

Gas bubbles may be outputted through the gas injecting holes 70 of the bottom surface of the bubble injector 60. In other words, the gas outputted from the gas line connected to the top end part of the first connection pipe 10 may sequentially pass through the first connection pipe 10, the tube connecting the first connection pipe 10 and the second connection pipe 50, and the second connection pipe 50 and then be injected into the reaction container 40 through the gas injecting holes 70 of the bottom surface of the bubble injector 60.

According to embodiments of the inventive concept, uniform nanoparticles may be manufactured by the bubble generation ultrasonic synthesis method. The nanoparticles may have excellent coating property and excellent dispersibility in various solvents.

The uniform metal oxide thin film may be formed by a spin coating process or an inkjet process using the nano-ink including the nanoparticles. The process may be performed at a low temperature. Thus, manufacturing costs of the nanoparticles may be reduced.

While the inventive concept has been described with reference to example embodiments, it will be apparent to those skilled in the art that various changes and modifications may be made without departing from the spirit and scope of the inventive concept. Therefore, it should be understood that the above embodiments are not limiting, but illustrative. Thus, the scope of the inventive concept is to be determined by the broadest permissible interpretation of the following claims and their equivalents, and shall not be restricted or limited by the foregoing description.

What is claimed is:

1. A method of manufacturing metal oxide nanoparticles, comprising:
forming a metal oxide preliminary composition solution;
mixing the metal oxide preliminary composition solution with a basic chemical species solution to form a mixture solution;
applying ultrasonic waves to the mixture solution to form a reactant; and
removing a solvent of the reactant.

2. The method of claim 1, further comprising:
injecting a gas into the metal oxide preliminary composition solution.

3. The method of claim 2, wherein the gas includes oxygen, nitrogen, argon, or vapor.

4. The method of claim 1, wherein the metal oxide preliminary composition solution is an alcohol-based solution including metal acetate, metal alkoxide, metal nitrade, metal halide, any hydrate thereof, or any combination thereof.

5. The method of claim 4, wherein the metal acetate, metal alkoxide, metal nitrade, metal halide, any hydrate thereof, or any combination thereof has a molarity within a range of about 0.1M to about 1M in the alcohol-based solution.

6. The method of claim 1, wherein the basic chemical species solution is a mixture of a basic chemical species and an alcohol-based solvent.

7. The method of claim 6, wherein the basic chemical species includes LiOH, NaOH, KOH, NH4OH, Na2O2, any hydrate thereof, or any combination thereof.

8. The method of claim 1, wherein the ultrasonic waves has a frequency within a range of about 30 kHz to about 100 kHz.

9. The method of claim 1, wherein the ultrasonic waves has a power within a range of about 600 W to about 3000 W.

10. The method of claim 1, wherein the solvent of the reactant is removed using a centrifuge method.
